(19) United States
(12) Patent Application Publication
(10) Pub. No.: US 2011/0042153 A1
(43) Pub. Date: Feb. 24, 2011

(54) TOUCH SENSING DEVICE AND METHOD USING RANDOM SPREAD SPECTRUM SIGNAL

(75) Inventors: Hung Wei Wu, Zhonghe City (TW); Chih-Yu Chang, Hsinchu City (TW)

Correspondence Address: AUSTIN RAPP & HARDMAN, 170 South Main Street, Suite 735, SALT LAKE CITY, UT, 84101, US

(73) Assignee: u-Pixel Technologies Inc., Hsinchu (TW)

(21) Appl. No.: 12/543,923

(22) Filed: Aug. 19, 2009

(51) Int. Cl. G08C 21/00

(52) U.S. Cl. 178/18.06

(57) ABSTRACT

A touch sensing device and method for detecting a touch event of a sensing array are disclosed. In the present invention, a random duration square wave signal is used to modulate a current or voltage signal so as to generate a modulated driving signal for driving a row of the sensing array. The random duration square wave signal has cycles of different durations so that the modulated driving signal also has the same cycles with the different durations. A sensing signal is measured from a column, for example, of the sensing array. Touching information is extracted by using the random duration square wave signal to demodulate the sensing signal.

### TECHNICAL FIELD OF THE INVENTION

The present invention relates to touch sensing, more particularly, to a touch sensing device which is able to disperse noise interferences over various frequencies.

### BACKGROUND OF THE INVENTION

A touch panel utilizes a sensing array to detect a position and strength of a touch done by a finger, stylus or the like. FIG. 1 is a schematic diagram showing a general touch sensing device 1 (e.g. a touch panel) having a sensing array 10. The sensing array 10 comprises a group of longitudinal conductive traces and a group of lateral conductive traces arranged as columns and rows of X-Y coordinates or arranged as polar coordinates, and a number of sensing elements (not shown) provided at the respective intersections. The sensing elements are usually implemented by resistors or capacitors, for example. A control unit 12 sends a driving signal to drive a row i of the sensing array 10 through a multiplexer 16. A sensing signal of the respective columns j of the driven row i are sequentially or simultaneously detected by the control unit 12 to determine the touch position and strength via a multiplexer 14. By checking values of the sensing signals, the touch position and strength can be known. For example, assuming a row has 16 nodes (i.e. 16 columns are intersected with each row), if the signal values of the sensing signal for the 16 nodes for a specific row are (0, 0, 0, 1, 2, 3, 4, 3, 2, 1, 0, 0, 0, 0, 0, 0), it means the seventh node gets a stronger touch. However, the sensing elements are sensitive to noises. Therefore, the values of the sensing signals are easily influenced so that it is difficult to accurately distinguish the touch position and determine the touch strength.

Nowadays, touch sensing devices such as touch panels have been widely used in various applications and get involved in many complicated functional operations such as wireless communication. Therefore, the touch panels may be interferences by various noises such as 1/f noise, white noise, power noise, 50/60 Hz noise, microwave (e.g. infrared, blue tooth etc.) noise, backlight noise or the like. The various noises are dispersed in different frequency bands. FIG. 2 shows the various noises and the how a signal is coupled with the noises. The upper diagram shows the distribution of the various noises such as 1/f noise 23, 60 Hz noise 25, local noises 27 and white Gaussian noise 29. The DC signal is indicated by a black arrow 21. The middle diagram shows an ideal sensing signal. The lower diagram shows a noise-coupled sensing signal. Generally, high frequency noises can be filtered off by using a low pass filter. However, if we attempt to filter off the noises of lower frequency bands by using a low pass filter with a low cut off frequency to extract DC term (i.e. the required signal), response time of the filter is slow. For example, if a cut off frequency of 10 Hz is used to filter off the 60 Hz noise, the response time will be delayed by 0.1 second. Such a delay will cause inconvenience in the operation of the touch panel.

In conventional modulation/demodulation technique, a carrier of frequency f1 can be used to modulate a voltage or current diving signal to driving rows and columns of the sensing array. Then the sensing signal obtained from the sensing array is demodulated by a demodulation signal of a frequency f2. By doing so, signals of frequencies of (f1+f2) and (f1−f2) are generated. If a low pass filter with a cut off frequency lower than (f1+f2)/2, then the high frequency components can be filtered off, and the low frequency component can be obtained. When f1=f2, the low frequency is the DC term, which is the required sensing signal. The touch event can be known from the DC term. The change of the DC term corresponds to the capacitance or resistance variance due to a touch. However, the carrier used to modulate the driving signal must be chosen to be in a band with low noise. If the carrier is of a band with high noise, SNR of the sensing signal will be degraded. Therefore, the carrier (i.e. modulation signal) must be selected from a low noise band. To know which one of the frequency bands has the lowest noise, it is required to scan and check all the bands. This increases the hardware and time costs.

### SUMMARY OF THE INVENTION

The present invention is to provide a touch sensing technique to disperse noise interferences over various frequencies.

In accordance with an aspect of the present invention, a touch sensing device for detecting a touch event of a sensing array, the touch sensing device comprises a driving circuit providing a random duration square wave signal to modulate an electrical signal such as a current or voltage signal so as to generate a modulated driving signal to drive a node of the sensing array; and a sensing circuit measuring a sensing signal from the node of the sensing array and extracting touching information of the node by using the random duration square wave signal. The random duration square wave signal has plural cycles with different durations so that the modulated driving signal also has the same cycles with the different durations.

In accordance with another aspect of the present invention, a touch sensing method for detecting a touch event of a sensing array, the touch sensing method comprises providing a random duration square wave signal; modulating an electrical signal so as to generate a modulated driving signal to drive a node of the sensing array; measuring a sensing signal from the node of the sensing array; and extracting touching information of the node by using the random duration square wave signal. The random duration square wave signal has plural cycles of different durations so that the modulated driving signal also has the same cycles with the different durations.

### BRIEF DESCRIPTION OF THE DRAWINGS

The present invention will be described in detail in conjunction with the appending drawings, in which:

FIG. 1 is a schematic diagram showing a general touch sensing device;

FIG. 2 shows distribution of noises and how a sensing signal is coupled with the noises;

FIG. 3 is a schematic diagram showing three PN codes and power spectrums thereof;

FIG. 4 is a schematic diagram showing modulation and demodulation for two signals in accordance with the present invention;

FIG. 5 is a schematic diagram showing a touch sensing device in accordance with the present invention;

FIG. 6 shows a random duration square wave signal generated by the touch sensing device of FIG. 5;

FIG. 7 is a flow chart shown the generation of the random duration square wave signal in accordance with the present invention;

FIG. 8 shows modulation and demodulation waveforms using the random duration square wave signal of the present invention;

FIG. 9 shows modulation and demodulation waveforms using a modified random duration square wave signal of the present invention;

FIG. 10 shows the modulation and demodulation waveforms as well as a sensing signal of the touch device in accordance with the present invention in touch and un-touch conditions;

FIG. 11 shows waveforms of an extracted signal output from a signal extractor of the touch device in accordance with the present invention;

FIG. 12 is a schematic diagram showing an application example of the touch sensing device in accordance with the present invention; and

FIG. 13 is a schematic diagram showing another application example of the touch sensing device in accordance with the present invention.

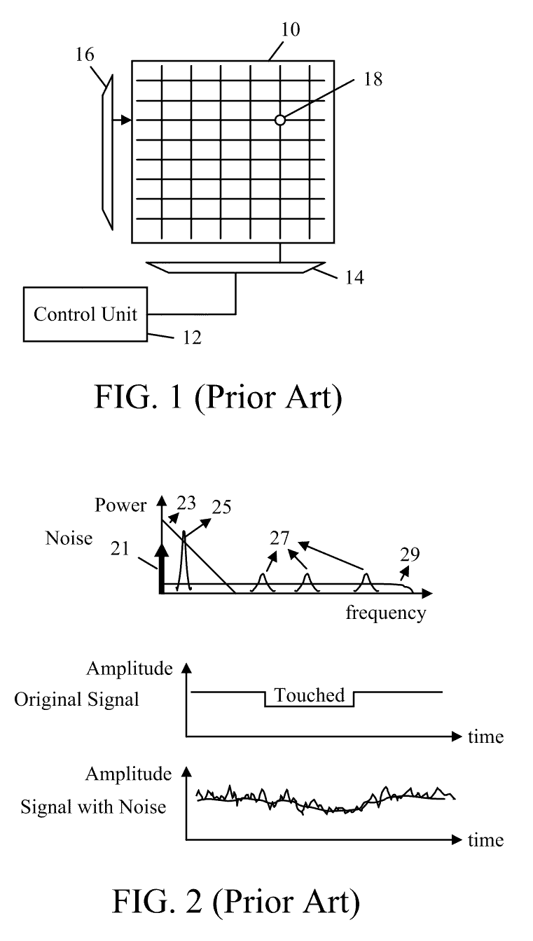

### DETAILED DESCRIPTION OF THE INVENTION

The present invention utilizes characteristics of orthogonal vectors. Assuming each vector of a vector group is Vi, where i=0, 1, . . . , n. If the product of a vector with a different vector is 0 (i.e. Vi×Vj=0, where i≠j), and the product of a vector with itself is 1 (i.e. Vi×Vj=1, where i≠j), the this is an orthogonal vector group. When V1=(a1, b1, c1, d1) and V2=(a2, b2, c2, d2), then the product of V1×V2 equals to a1×a2+b1×b2+c1×c2+d1×d2. For example, if the vector group includes two vectors: V1=(0, 0, 0, 1) and V2=(0, 0, 1, 0), it is satisfied that V1×V×=1, V1×V2=0, and V2×V2=1. Therefore, V1 and V2 are orthogonal with each other.

Any signal can be represented by an orthogonal vector group as S=c1V1+c2V2+c3V3+ . . . +cnVn, where c1, c2, . . . , cn are coefficients. If the environmental noises are represent as N=100V1+50V2+20V3+10V4+2V5+4V6+10V7 . . . , where each of the vectors V1, V2, . . . indicates a component of a specific frequency band. For a known signal A, if V5 is selected as a modulation vector, then the modulated signal (i.e. input signal) Si=AV5. As known, the signal will be coupled by the noises, therefore, an output signal So=AV5+100V1+50V2+20V3+10V4+2V5+4V6+10V7 . . . =00V1+50V2+20V3+10V4+(A+2)V5+4V6+10V7 . . . . If we utilize the same vector V5 as a demodulation vector, then the recovered signal Sr=So×V5=100×0+50×0+20×0+10×0+(A+2)×1+4×0+10×0 . . . =A+2.

If we use two different vectors to modulate two signals, we can extract the two signals by using the two different vectors as demodulation vectors. For example, assuming a vector V5 is selected to modulate a signal A, and a different vector V6 is selected to modulate another signal B, then an input signal is Si=AV5+BV6. The input signal is coupled with noises, then an output signal will be So=AV5+BV6+100V1+50V2+20V3+10V4+2V5+4V6+10V7 . . . =100V1+50V2+20V3+10V4+(A+2)V5+(B+4)V6+10V7 . . . . When we use the vector V5 to demodulate the output signal, the signal A can be recovered as SrA=So×V5=100×0+50×0+20×0+10×0+(A+2)×1+(B+4)×0+10×0 . . . =A+2. If the vector V6 is used to demodulate the output signal, the signal B can be recovered as SrB=So×V6=100×0+50×0+20×0+10×0+(A+2)×0+(B+4)×1+10×0 . . . =B+4. By using multiple different vectors, multipoint of a sensing array can be processed at the same time. The details will be further described later.

As can be seen, only a little noise will be left with the recovered signal. However, as mentioned above, to lower the noises, the low noise component (e.g. V5 in this example) should be selected as the modulation and demodulation vector.

In order to avoid scanning all the bands to find the band with the least noise, we utilize the random spread spectrum (RSS) technique. Each selected vector for modulation and demodulation is a random combination of frequencies, and therefore the recovered signal will be seriously attacked by noises of a specific band. Preferably, the selected vector changes from time to time. For example, at time t1, a selected vector is (¼)V3+(¼)V5+(¼)V7+(¼)V8, and at time t2, a selected vector is (⅓)V4+(⅓)V5+(⅓)V8. In practice, pseudorandom noise (PN) code technique can be used.

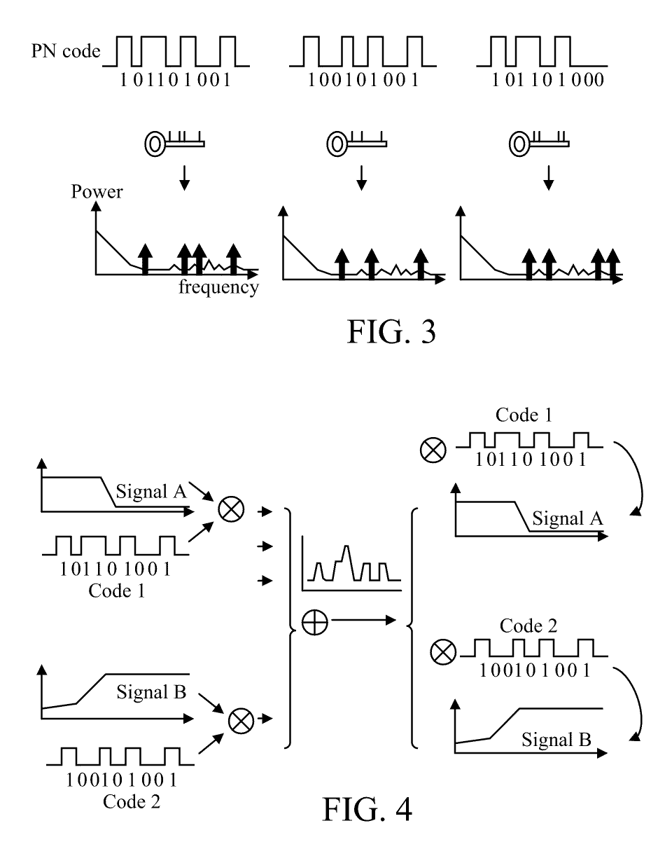

FIG. 3 is a schematic diagram showing three different PN codes and power spectrums thereof. Each PN code is like a key. As can be seen, power components of the three PN codes indicated by black arrows disperse at different frequencies. Therefore, spread spectrum can be attained. FIG. 4 is a schematic diagram showing modulation and demodulation for two signals A and B in accordance with the present invention. The signal A is modulated by code 1 and the signal B is modulated by code 2. The modulated signals are combined as a combination signal Sc. The signal A can be recovered from the combination signal Sc by using code 1 to demodulate the combination signal Sc. The signal B can be recovered from the combination signal Sc by using code 2 to demodulate the combination signal Sc.

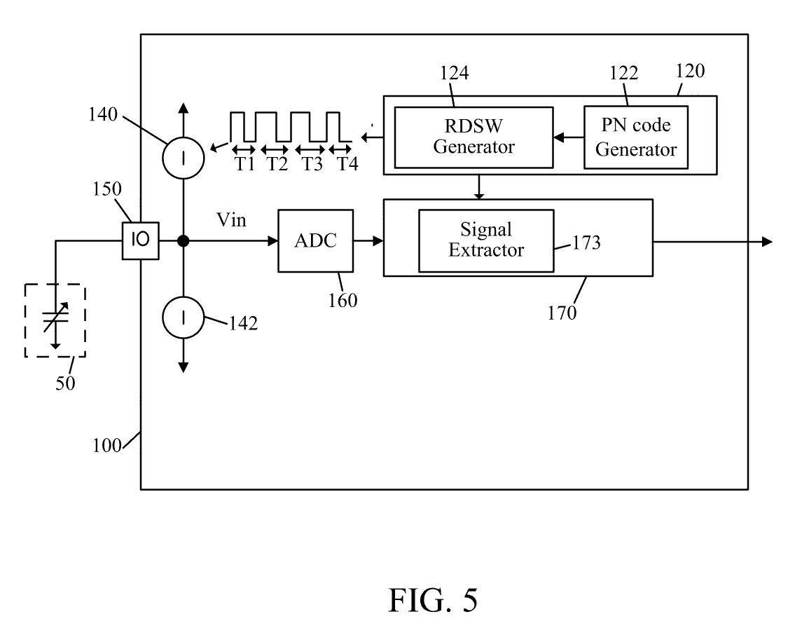

FIG. 5 is a schematic diagram showing a touch sensing device 100 in accordance with the present invention. The touch sensing device 100 comprises a driving circuit 120, signal sources such as current sources 140, 142 for charging and discharging a capacitance node 50 of a sensing array (not shown), an I/O interface 150, an analog-to-digital converter 160 and a sensing circuit 170. In the present invention, the driving circuit 120 has a pseudorandom noise (PN) code generator 122, which generates and provides a PN code. The PN code is sent to a random duration square wave (which is referred to as “RDSW” hereinafter) generator 124. The RDSW generator 124 generates a signal includes pulses having different durations based on the PN code provided by the PN code generator 122.

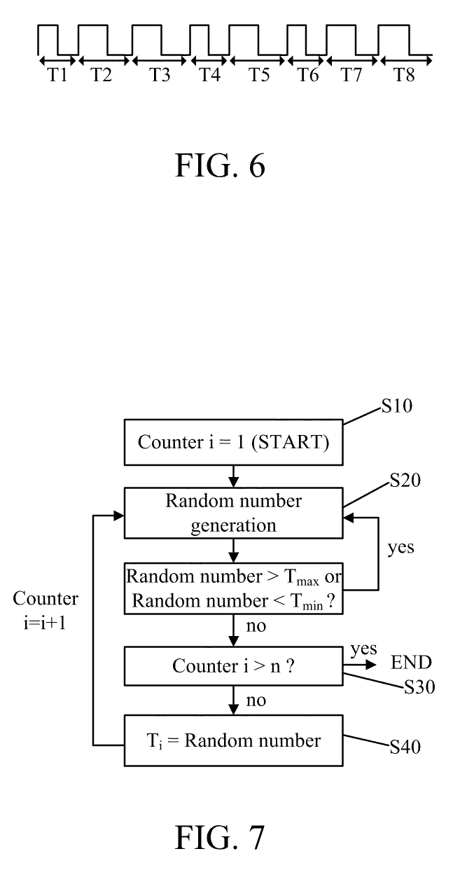

FIG. 6 shows a random duration square wave (RDSW) signal generated by the touch sensing device of FIG. 5. As shown, the RDSW signal comprises at least eight cycles with different durations T1, T2, . . . , T8 . . . . The respective durations of the RDSW signal are determined by random numbers. For example, a RDSW signal Ti, where i=1 to 8, is generated based on a sequence of random numbers (101, 235, 76, 104, 223, 94, 160, 112). The first duration T1 of the RDSW signal corresponds to 101, the second duration T2 corresponds to 235, and the rest can be deduced accordingly. The RDSW signal is used to modulate a current signal provided by the current sourced 140, 142 to form a RDSW modulated driving signal. In the present embodiment, the RDSW modulated driving signal is sent to drive the capacitance node 50 via the I/O interface 150. That is, the capacitance node 50 is charged/discharged based on the RDSW modulated driving signal. As widely known in this field, a capacitance change of the capacitance node 50 due to a touch will react as a voltage variation of the sensing signal Vin.

A sensing signal Vin is measured from the capacitance node 50 via the I/O interface 150. The sensing signal Vin in a voltage signal. To deal with the sensing signal Vin in digital, the sensing signal Vin is converted into digital by the ADC 160. However, the ADC 160 can be omitted and the analog sensing signal Vin is processed directly. A signal extractor 173 in the sensing circuit 170 extracts the voltage variation indicated the capacitance change of the capacitance node 50 by using the same RDSW signal generated by the RDSW generator 124. The signal extractor 173 generates a demodulation signal based on the RDSW signal to demodulate the sensing signal Vin. Therefore, the sensing circuit 170 can output the voltage variation information in correspondence to the capacitance change, which indicates touching information of the capacitance node 50.

FIG. 7 is a flow chart shown the generation of the random duration square wave (RDSW) signal having multiple cycles with various durations Ti (for i=1 to n) in accordance with the present invention. The process starts at step S10, a counter i=1. In step S20, a random number is generated. In step S30, it is determined whether the random number is in a proper range so that the duration falls in a range between Tmax and Tmin. The upper limit Tmax and the lower limit Tmin are used to limit the range of the durations of the RDSW signal. The maximum duration of the RDSW signal cannot exceed Tmax so as to avoid over charging the capacitance node 50. The minimum duration of the RDSW signal should be longer than Tmin so that a pulse of the sensing signal can be detected assuredly. If the generated random number is not in the proper range, the process goes back to the step S20 to regenerate a new random number. In the generated random number is in the proper range, the process goes to step S30 to check if the counter i has exceeded a predetermined number n. If so, the process is ended. If not, the duration Ti is determined based on the random number in step S40. In addition, the counter i is added by 1 and the process goes back to step S20 and circulates again.

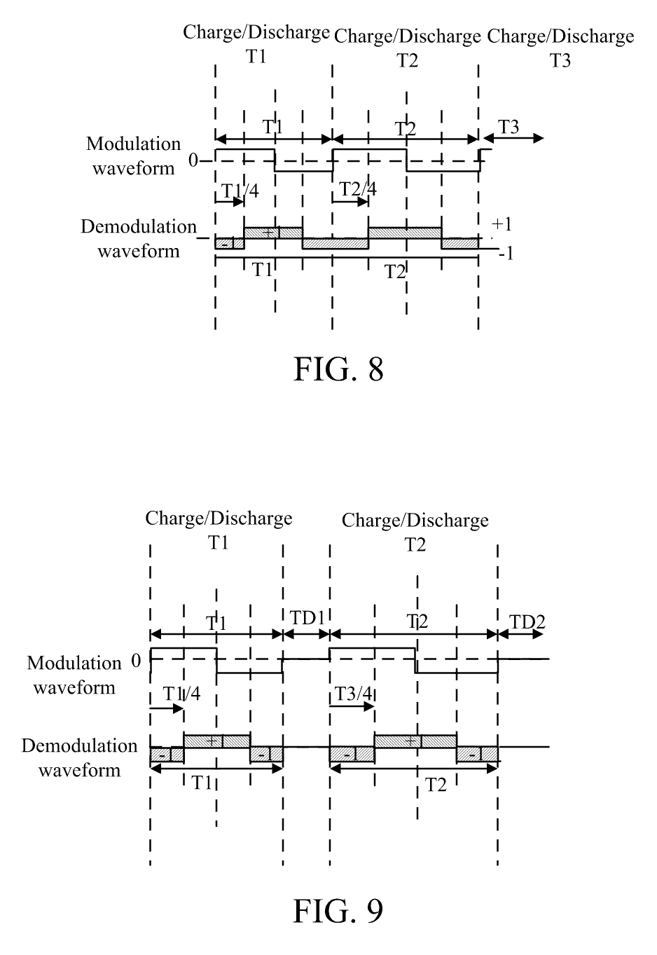

FIG. 8 shows modulation and demodulation waveforms using the random duration square wave (RDSW) signal in accordance with the present invention. As described, the RDSW modulated driving signal is modulated by the RDSW signal provided by the driving circuit 120 of the touching sensing device 100 in FIG. 5. That is, the RDSW signal is used as the modulation signal to modulate the current signal provided by the current sources. When the modulated driving signal is high, the capacitance node 50 is charged. When the modulated driving signal is low, the capacitance node 50 is discharged. The sensing circuit 170 generates a demodulation signal based on the RDSW signal but having a phase shift of 90 degree. As shown, the demodulation signal has the same waveform as the modulation signal with a phase delay of Ti/4. That is, the first square wave cycle of the demodulation signal is delayed by T¼ with respect to that of the modulation signal, the second square wave cycle of the demodulation signal is delayed by T 2/4 with respect to that of the modulation signal, and the rest can be deduced accordingly.

The demodulation performed by the signal extractor 173 may be implemented by multiplying and adding. For example, an MAD (multiply and add) accumulator (not shown, which is implemented by a multiply-accumulate instruction code) of a DSP MCU (digital signal processing microprocessor control unit) can be used. If the sensing signal Vin is (2, 2.3, 2.6, 2.8, 3.1, 3.4, . . . ) and the RDSW signal is (−1, −1, −1, 1, 1, 1, . . . ), then the accumulated result is 2×(−1)+2.3×(−1)+2.6×(−1)+2.8×(1)+3.1×(1)+3.4×(1)+ . . .

To increase the randomness of the RDSW signal, a dummy interval TD can be added between two durations. FIG. 9 shows modulation and demodulation waveforms using a modified random duration square wave (RDSW) signal of the present invention. In the dummy interval, no signal is transferred. That is, the signal value of the driving signal in the dummy interval is zero. As shown in the drawing, between the first duration Ti and the second duration T2, a first dummy interval TD1 is inserted. After the second duration T2, a second dummy interval TD2 is inserted. The rest can be deduced accordingly. Preferably, the lengths of the respective dummy intervals are also randomly determined.

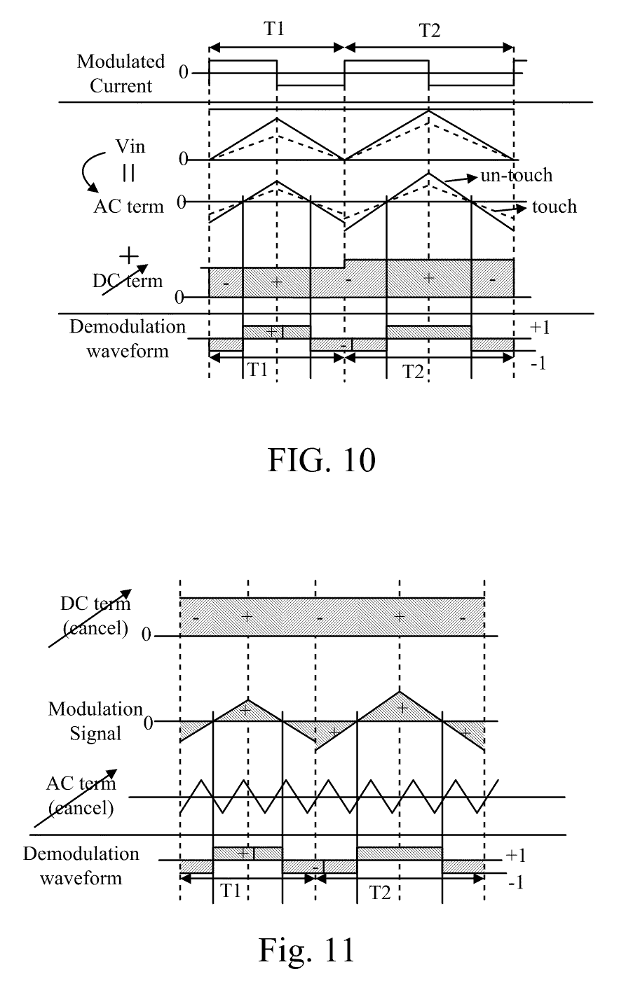

For better understanding of the present invention, the modulation and demodulation waveforms will be further described with reference to FIG. 10. FIG. 10 shows the modulation and demodulation waveforms as well as the sensing signal Vin of the touch device 100 in accordance with the present invention in touch and un-touch conditions. The uppermost shows the waveform of the RDSW modulated current signal (i.e. the driving signal). The sensing signal Vin is shown in the middle portion. The solid line indicates a waveform under the un-touch condition, while the dashed line indicates a waveform under the touch condition. As shown, the sensing signal Vin can be expressed as a summation of AC term and DC term. After being demodulated with the RDSW signal, the positive and negative components of the DC term are cancelled with each other. For the AC term, only the contributions of the components of the same frequencies as the modulation signal (i.e. the frequencies of the RDSW signal) are left. Since the frequencies of the RDSW signal are determined according to the random numbers (e.g. the PN code), the noise interferences are dispersed over the whole frequency spectrum randomly.

The signal extractor 173 in FIG. 5 is able to extract a portion of the sensing signal Vin, which has the same random durations as the RDSW signal generated by the RDSW generator 124. FIG. 11 shows waveforms of an extracted signal output from the signal extractor 173 of the touch device 100 in accordance with the present invention. As can be seen, the positive and negative components of the DC term are cancelled with each other. After being demodulated, the signal value of the signal portion having the random durations the same as the RDSW signal is the summation of all the shaded blocks. The signal value indicates the measured capacitance. Other signal portions have their positive and negative components cancelled with each other.

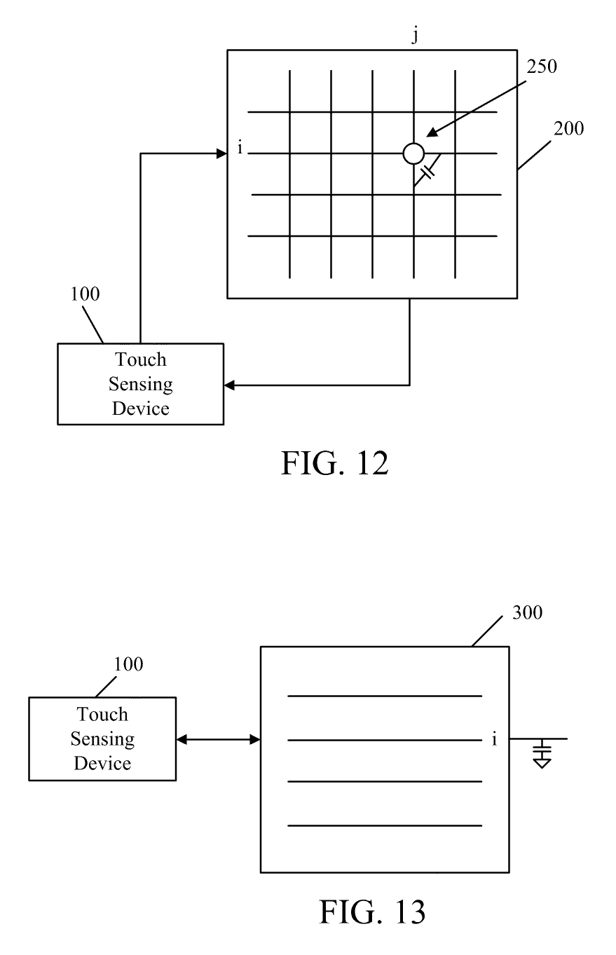

The touch sensing device 100 can be applied to measure self capacitance(s) or mutual capacitance(s) of at least one node of a group of patterned conductors. FIG. 12 is a schematic diagram showing an application example of the touch sensing device 100 in accordance with the present invention. The touch sensing device 100 is connected to a sensing array 200. The sensing array 200 has a group of pattern conductors arranged as N columns×M rows. The touch sensing device 100 provides a RDSW modulated driving signal to a row i, and measures a sensing signal from a column j. Accordingly, a change of the mutual capacitance of the row i and the column j can be obtained. The change of the mutual capacitance of the row i and the column j indicates the touching information of the node 250, which is the intersection of the row i and the column j. FIG. 13 is a schematic diagram showing another application example of the touch sensing device 100 in accordance with the present invention. The touch sensing device 100 is connected to a sensing array 300. The sensing array 300 has a group of pattern conductors arranged as N columns×M rows. The touch sensing device 100 provides a RDSW modulated driving signal to a row i of the sensing array 300, and measures a sensing signal from the same row i. Accordingly, the changes of self capacitances of all nodes over the row can be detected. Although the above embodiments and application examples are described by using the capacitive sensing array, it can be easily understood that the technique of the present invention can also be used a resistive sensing array.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A touch sensing device for detecting a touch event of a sensing array, the touch sensing device comprising:
a driving circuit providing a random duration square wave signal to modulate an electrical signal so as to generate a modulated driving signal for driving a node of the sensing array; and
a sensing circuit measuring a sensing signal from the node of the sensing array and extracting touching information of the node by using the random duration square wave signal,
wherein the random duration square wave signal has plural cycles of different durations so that the modulated driving signal also has the same cycles with the different durations.

2. The touch sensing device of claim 1, wherein the durations of the random duration square wave signal are determined based on random numbers.

3. The touch sensing device of claim 1, wherein the durations of the random duration square wave signal are limited in a range defined by an upper limit and a lower limit.

4. The touch sensing device of claim 1, wherein a dummy interval is inserted between two cycles of the random duration square wave signal, a signal value of the modulated driving signal is zero during the dummy interval.

5. The touch sensing device of claim 1, wherein the driving circuit comprises a pseudorandom noise (PN) code generator for providing a PN code, and a random duration square wave generator determines the different durations for the random duration square wave signal based on the PN code.

6. The touch sensing device of claim 1, wherein the sensing circuit comprises a signal extractor for extracting the touching information of the node by using the random duration square wave signal.

7. The touch sensing device of claim 6, wherein the signal extractor demodulates the sensing signal with the random duration square wave signal to extract the touching information of the node.

8. The touch sensing device of claim 1, wherein the node is an intersection of a specific row and a specific column, the modulated driving signal is used drive the specific row and the sensing signal is measured from the specific column.

9. The touch sensing device of claim 1, wherein the node is at a specific row, the modulated driving signal is used drive the specific row and the sensing signal is measured from the same row.

10. A touch sensing method for detecting a touch event of a sensing array, the touch sensing method comprising:
providing a random duration square wave signal;
modulating an electrical signal so as to generate a modulated driving signal for driving a node of the sensing array;
measuring a sensing signal from the node of the sensing array; and
extracting touching information of the node by using the random duration square wave signal,
wherein the random duration square wave signal has plural cycles of different durations so that the modulated driving signal also has the same cycles with the different durations.

11. The touch sensing method of claim 10, wherein the durations of the random duration square wave signal are determined based on random numbers.

12. The touch sensing method of claim 11, wherein the durations of the random duration square wave signal are determined based on a pseudorandom noise (PN) code.

13. The touch sensing method of claim 10, wherein the durations of the random duration square wave signal are limited in a range defined by an upper limit and a lower limit.

14. The touch sensing method of claim 10, wherein a dummy interval is inserted between two cycles of the random duration square wave signal, a signal value of the modulated driving signal is zero during the dummy interval.

15. The touch sensing method of claim 10, wherein the node is an intersection of a specific row and a specific column, the modulated driving signal is used drive the specific row and the sensing signal is measured from the specific column.

16. The touch sensing method of claim 10, wherein the node is at a specific row, the modulated driving signal is used drive the specific row and the sensing signal is measured from the same row.
